(19) United States
(12) Patent Application Publication
(10) Pub. No.: US 2016/0099994 A1
(43) Pub. Date: Apr. 7, 2016

(54) INFORMATION PROCESSING APPARATUS AND INFORMATION PROCESSING SYSTEM

(71) Applicant: KABUSHIKI KAISHA TOSHIBA, Tokyo (JP)

(72) Inventors: Hiroshi KAWAZOE, Kawasaki (JP); Narumichi SAKAI, Fujisawa (JP); Hiroyuki AIZU, Yokohama (JP)

(21) Appl. No.: 14/828,659

(22) Filed: Aug. 18, 2015

(30) Foreign Application Priority Data
Oct. 7, 2014 (JP) 2014-206790

(51) Int. Cl. H04L 29/08; H04L 12/911

(52) U.S. Cl. CPC H04L 67/02; H04L 47/78

(57) ABSTRACT

One embodiment relates to an information processing apparatus which sends data via plural sockets by connection-type communications in response to a data request from a request source apparatus. The information processing apparatus includes: a dividing unit which divides the data into plural divisional data, in terms of a division number of the plural divisional data or a data amount of each divisional data; an allocating unit which allocates the divisional data produced by the dividing unit to the plural sockets; and a providing unit which provides the request source apparatus with the divisional data allocated by the allocating unit and a script via the plural sockets. The script causes the request source apparatus to establish communications to be performed with the information processing apparatus via the plural sockets, collect the divisional data produced by the dividing unit, and combine the collected divisional data together.

### CROSS-REFERENCE TO RELATED APPLICATION(S)

This application claims priority from Japanese Patent Application No. 2014-206790 filed on Oct. 7, 2014, the entire contents of which are incorporated herein by reference.

### FIELD

An embodiment described herein generally relates to an information processing apparatus and an information processing system which exchange information using HTTP (Hypertext Transfer Protocol).

### BACKGROUND

A server and a client that are connected to each other via a network exchange information using HTTP.

When a client as a request source apparatus sends, to a server on the web, a request for transmission of data, the server transmits the data as a response to it. Documents that are exchanged on the web are called web pages and are usually consist of an HTML (Hypertext Markup Language) file, a moving image file, etc. Reference information for the URL (uniform resource locator) of a moving image file is buried in an HTML file. A browser application on a client acquires the HTML file from a server, and also acquires the moving image file buried therein from the server by referring its URL and displays it in a web page.

A data transmission (HTTP response) corresponding to a data transmission request using HTTP (HTTP request) is done in the form of one TCP (Transmission Control Protocol) stream. TCP data transmission is associated with, in particular, a problem that the throughput of one stream has an upper limit due to a TCP congestion control in a wideband, long-delay communication channel environment of a broadband Internet, a wireless network, etc. This results in a problem that the efficiency of use of the bandwidth of a communication channel lowers; in particular, it takes long time to complete a transmission of large-size data such as a moving image.

One approach to solve this problem is known in which influences of a TCP congestion control are reduced by establishing plural TCP streams rather than a single one and transmitting data in parallel.

However, there is difficulty applying this technique to HTTP data transmissions: applications in both of a server and a client need to be modified so as to be able to handle plural TCP streams instead of a single one. However, it is very difficult to make such modifications in common, widely used browser applications.

### BRIEF DESCRIPTION OF DRAWINGS

A general architecture that implements the various features of the present invention will now be described with reference to the drawings. The drawings and the associated descriptions are provided to illustrate embodiments and not to limit the scope of the present invention.

FIG. 1 shows an example configuration of an information processing system according to an embodiment.

FIG. 2 shows a state of the information processing system that appears when a client has received a script file from a server in the embodiment.

FIG. 3 illustrates an example manner of division performed by a dividing unit in the embodiment.

FIG. 4 shows an example configuration of an information processing system according to another embodiment in which a script file includes a requesting section.

FIG. 5 shows a procedure for determining the number of sockets in an information processing system according to still another embodiment.

FIG. 6 shows an example configuration of an information processing system according to a further embodiment in which data is transmitted from a client to a server.

### DETAILED DESCRIPTION

According to one embodiment, there is provided an information processing apparatus which sends data via plural sockets by connection-type communications in response to a data request from a request source apparatus. The information processing apparatus includes: a dividing unit which divides the data into plural divisional data, in terms of a division number of the plural divisional data or a data amount of each divisional data; an allocating unit which allocates the divisional data produced by the dividing unit to the plural sockets; and a providing unit which provides the request source apparatus with the divisional data allocated by the allocating unit and a script via the plural sockets. And, the script causes the request source apparatus to establish communications to be performed with the information processing apparatus via the plural sockets, collect the divisional data produced by the dividing unit, and combine the collected divisional data together.

Information processing apparatus according to embodiments will be hereinafter described with reference to the drawings.

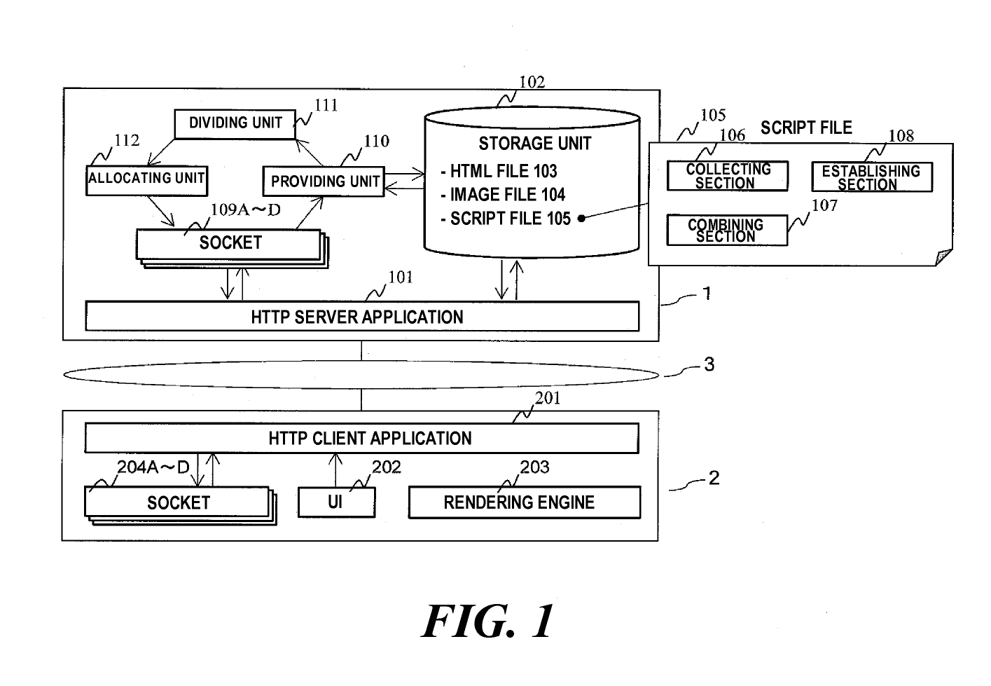

FIG. 1 shows an information processing system in which an information processing apparatus that functions as an HTTP server (hereinafter referred to as a server 1) and an information processing apparatus that functions as an HTTP client (hereinafter referred to as a client 2) are connected to each other by a network 3.

The server 1, which provides the client 2 with HTTP content data, includes, as constituent elements, an HTTP server application 101, a storage unit 102, sockets 109A-109D, a providing unit 110, a dividing unit 111, and an allocating unit 112.

The storage unit 102 may be one or more of storage devices. The HTTP server application 101 may be stored in the storage unit 102. Alternatively the HTTP server application 101 may be stored in another storage unit or medium.

The HTTP server application 101, the sockets 109A-109D, the providing unit 110, the dividing unit 111 and the allocating unit 112 may be realized by one or more of processors which are not shown.

The HTTP server application 101 receives an HTTP request from the client 2 and sends, as an HTTP response, a data file that is designated by the HTTP request.

The storage unit 102 is stored with an HTML file 103, a content such as an image file 104, and a script file 105. The HTML file 103 is a document that is written in HTML, and includes reference information for the URL of the script file 105. The image file 104 is an image to be displayed in a picture of the HTML file 103.

The script file 105 is a file that is written in a script language, and controls the operation of the client 2 (the details of how the script file 105 works will be described later). The script file 105 includes a collecting section 106, a combining section 107, and an establishing section 108.

The collecting section 106 collects data that are received via plural sockets (described later in detail).

The combining section 107 combines together the data collected by the collecting section 106.

The establishing section 108 establishes communications to be performed between the server 1 and the client 2 through plural sockets.

The sockets 109A-109D are interfaces for connection-type communications to be performed with the client 2. In the embodiment, communications are performed according to WebSocket which is a technical standard that is provided in common browsers as a standard item.

The providing unit 110 serves to provide the client 2 with the image file 104 which is stored in the storage unit 102.

The dividing unit 111 divides the data of the image file 104 into plural portions having proper data amounts.

The allocating unit 112 allocates the divisional data produced by the dividing unit 111 to the respective sockets 109A-109D.

The client 2 includes, as constituent elements, an HTTP client application 201, a user interface (hereinafter abbreviated as UI) 202, a rendering engine 203, and sockets 204A-204D.

The HTTP client application 201 may be stored in one or more of storage devices which are not shown.

The HTTP client application 102, the UI 202, the rendering engine 203 and the sockets 209A-209D may be realized by one or more of processors which are not shown.

The HTTP client application 201 requests the server 1 to transmit data by sending an HTTP request to it and displays data that is received in the form of an HTTP response.

The UI 202 provides an input/output means for a user of the client 2.

The rendering engine 203 is an execution unit for interpreting contents written in HTML and calculates an arrangement of texts and images to be displayed on the screen, as well as for performing necessary processing according to the details of a script file that is written in a script language.

The sockets 204A-204D are interfaces for connection-type communications to be performed with the server 1. The sockets 204A-204D perform communications with the sockets 109A-109D of the server 1 according to a prescribed technical standard.

Next, operations performed by the information processing system shown in FIG. 1 will be described with reference to FIG. 1.

First, the client 2 sends, to the server 1, a request for transmission of the HTML file 103. A user of the client 2 specifies a URL of the image file 104 stored in the server 1 by manipulating the UI 202. For example, the UI 202 is an address bar of a browser and the URL is a character string such as “http://www.example.com/index.html.” Upon input of the URL, the HTTP client application 201 generates an HTTP request containing this URL and sends it to the server 1 over the network 3.

Upon reception of the HTTP request, the HTTP server application 101 of the server 1 acquires the designated HTML file 103 from the storage unit 102, generates an HTTP response containing it, and sends the generated HTTP response to the client 2 over the network 3.

The rendering engine 203 of the client 2 interprets the received HTML file 103. The HTML file 103 contains the reference information for the URL of the script file 105.

The HTTP client application 201 generates an HTTP request containing the URL of the script file 105 and sends the generated HTTP request to the server 1 in the same manner as it sent the HTTP request for the HTML file 103.

The HTTP server application 101 of the server 1 acquires the script file 105 from the storage unit 102 and sends it to the client 2 as an HTTP response. Although in the embodiment the HTML file 103 and the script file 105 are separate files, the embodiment is not limited to such a case; a similar script may be buried in the HTML file 103.

The rendering engine 203 of the client 2 executes the received script file 105. The establishing section 108 of the script file 105 operates first, that is, performs processing for establishing a WebSocket connection with the server 1 plural times. To establish a WebSocket connection, the HTTP client application 201 sends a handshake request to the server 1. The HTTP server application 101 of the server 1 returns a handshake response.

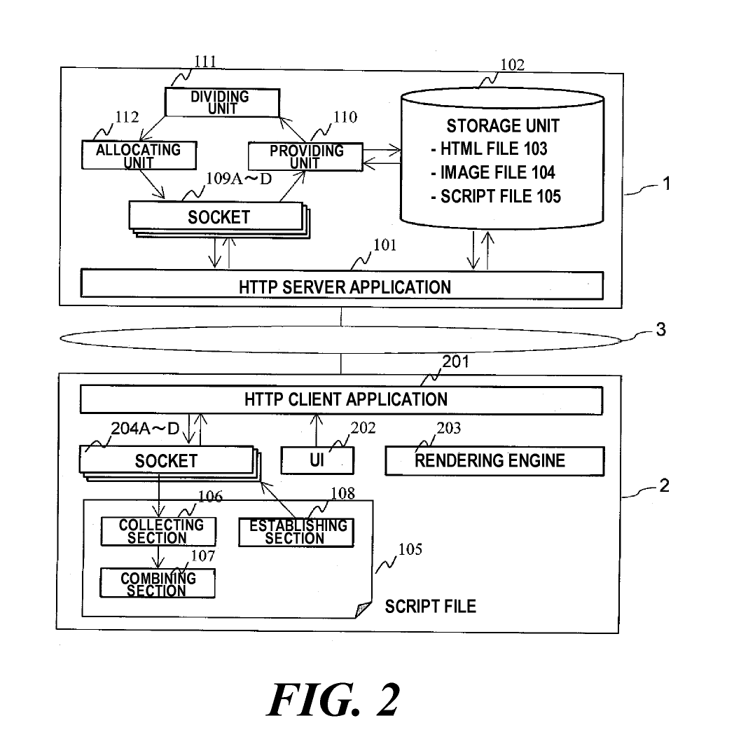

As a result of the above operations, establishment of a WebSocket connection is completed and a pair of sockets (e.g., a pair of sockets 109A and 204A) are generated to the server 1 and the client 2. The HTTP client application 201 performs such connection establishment processing plural times (in the embodiment, four times), whereby plural pairs of sockets (i.e., the sockets 109A-109D are paired with the respective sockets 204A-204D) are generated. FIG. 2 shows a state (configuration) that appears as a result of completion of the above operations.

In the server 1, the providing unit 110 functions as an “onopen” event handler to respond to establishment of a WebSocket connection. Upon receiving a notice of establishment of connections using all of the sockets 109A-109D, the providing unit 110 starts sending the image file 104 using the plural WebSocket connections. The providing unit 110 acquires the image file 104 from the storage unit 102 and passes it to the dividing unit 111.

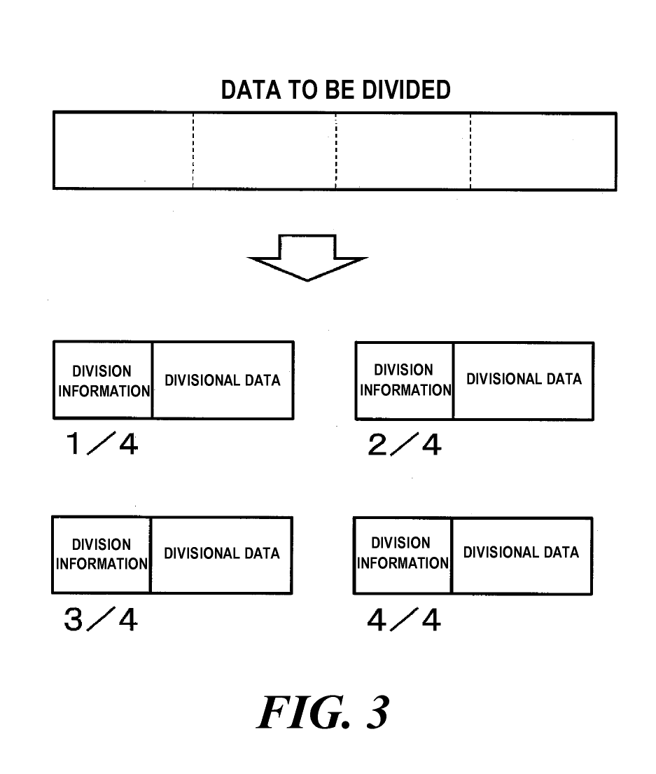

The dividing unit 111 performs division processing on the received data. FIG. 3 illustrates an example manner of division. In this example, the image file 104 is divided equally into four divisional data having the same size and division information is added to each of the divisional data at its head. The division information is information indicating a manner of division; in the embodiment, the division information is a set of a total number of divisional data (in this example, four) and an order number (one of “1” to “4”) indicating where the associated divisional data stands in the succession of the divisional data. The divisional data that are added with the respective pieces of division information are passed to the allocating unit 112.

The allocating unit 112 allocates the divisional data to the respective sockets 109A-109D. In this example, the four divisional data are allocated to the four respective sockets 109A-109D. The divisional data are transmitted to the respective sockets 204A-204D of the client 2 by Websocket communications.

The collecting section 106 of the script file 105 now existing in the client 2 receives the divisional data through the respective sockets 204A-204D. The collecting section 106, which functions as a Websocket “onmessage” event handler, refers to the pieces of division information added to the respective reception divisional data and holds data being received until all of the divisional data are received. Upon receiving all of the divisional data, the collecting section 106 passes them to the combining section 107. The combining section 107 removes the pieces of division information from the received divisional data and combines their byte sequences together according to the order numbers.

The script processing of each of the collecting section 106 and the combining section 107 is performed by the rendering engine 203.

Upon acquisition of the original data (image file 104), it is used by a desired method. For example, an instruction to the effect that the image should be displayed in a web page is described in the script file 105 and the image is displayed according to the instruction.

As described above, according to the embodiment, influences of a TCP congestion control can be reduced by downloading data in parallel using plural Websocket connections. As a result, the time taken to complete the download can be shortened. The embodiment provides another advantage that browsers need not be altered because WebSocket is used that is provided in existing browsers.

Although in the above embodiment processing for transmitting the image file 104 is started being triggered by the providing unit 110's receiving a notice of completion of establishment of WebSocket connections, the embodiment is not limited to such a case.

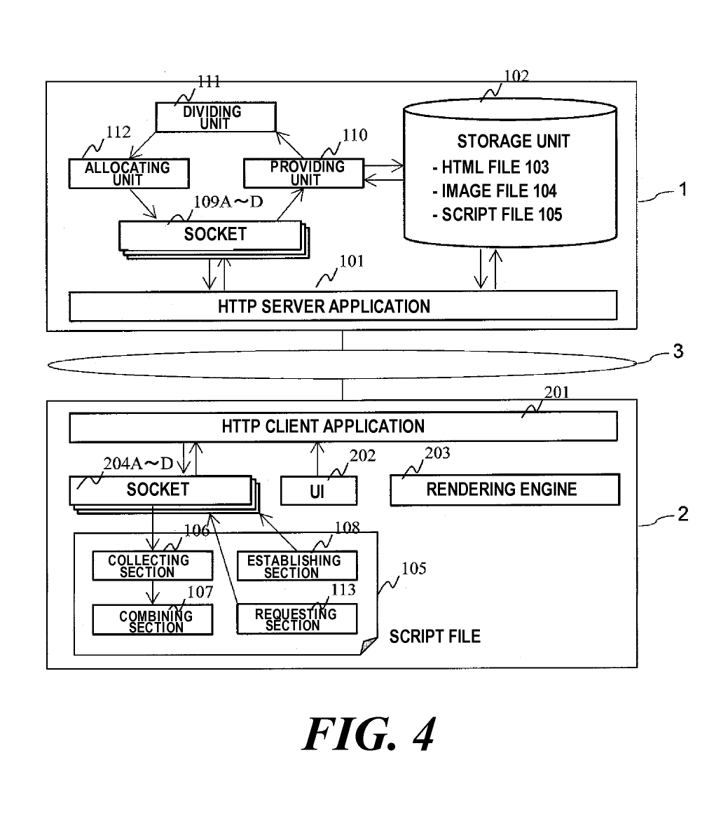

For example, the script file 105 may further be provided with a requesting section 113. FIG. 4 shows such a configuration.

In the client 2, the requesting section 113 functions as an “onopen” event handler to response to establishment of a WebSocket connection and receives connection establishment completion notices from the respective sockets 204A-204D. In response to the notices, the requesting section 113 sends the server 1 a request for transmission of the image file 104 through the sockets 204A-204D.

This transmission request, which contains a file name (e.g., “image.jpg”) of the image file 104 etc., is communicated to the providing unit 110. The following procedure is the same as described above. That is, the image file 104 may be either pushed from the server 1 or pulled from the client 2. The transmission request may contain information indicating a division number in addition to the file name of the image file 104. In this case, upon receiving the transmission request, the providing unit 110 passes the specified division number to the dividing unit 111. And the dividing unit 111 divides the image file 104 into the specified division number of divisional data.

Although in the above embodiments the number of sockets 109A-109D is fixed (to four), the embodiments are not limited to such a case; it may be determined dynamically.

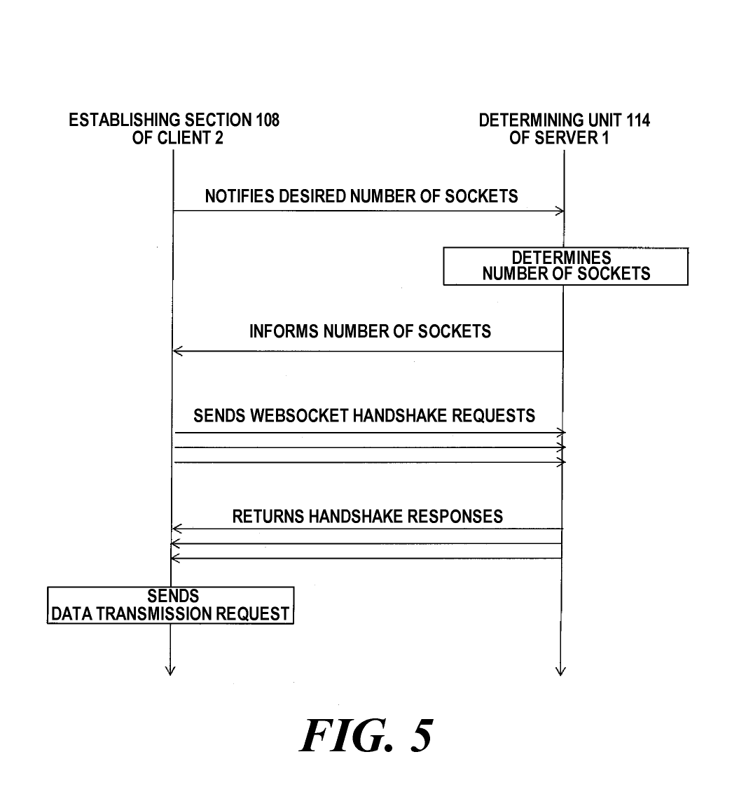

FIG. 5 shows a procedure that is followed by a configuration in which the server 1 is further equipped with a determining unit 114 which determines the number of sockets. First, the establishing section 108 generates only one socket. Upon generating one socket, the establishing section 108 informs, via the generated socket, the determining unit 114 of the server 1 of a desired number of sockets to be used simultaneously. A desired number may be determined by any method.

The determining unit 114 determines, by any of various methods, the number of sockets that can be used simultaneously. For example, the determining unit 114 holds, as a prescribed number, the number of sockets that can be used simultaneously. The determining unit 114 may employ, as the number of sockets that can be used simultaneously, a smaller one of the prescribed number and the desired number communicated from the client 2.

If the number of clients 2 to which the server 1 is providing services currently is larger than a prescribed threshold number, the determining unit 114 may employ a smaller number than ordinarily as the number of sockets that can be used simultaneously

The number of sockets that can be used simultaneously may be determined on the basis of necessary quality of a communication channel to be established between the server 1 and the client 2.

A larger number than ordinarily may be employed if the file size of the image file 104 is larger than a prescribed threshold value.

The determining unit 114 informs the establishing section 108 of the thus-determined number of sockets. In response, the establishing section 108 generates the received number of sockets (i.e., sends WebSocket handshake requests). Upon receiving a notice of completion of generation of sockets, the establishing section 108 sends a request for transmission of the image file 104.

In this case, since plural kinds of information are transmitted from the server 1 to the client 2 (i.e., the image file 104 and the notice of the number of sockets (from the determining unit 114)), they are transmitted in mixture through the sockets. To discriminate between the plural kinds of information, they may be added with respective pieces of header information at their heads. Alternatively, different sets of sockets may be used for transmission of different kinds of information.

Although the above embodiments are directed to data transmission only from the server 1 to the client 2, the embodiments are not limited to such a case. The embodiments can also be modified to applied to data transmission from a client 2 to a server 1.

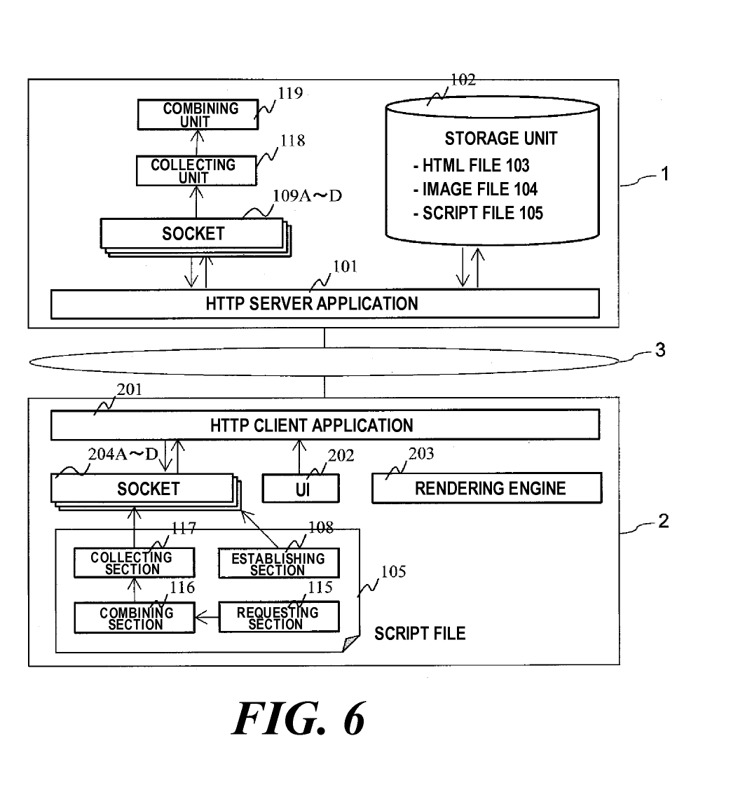

FIG. 6 shows an example configuration of an information processing system according to a further embodiment in which the server 1 is equipped with a collecting unit 118 and a combining unit 119 which collect and combine data received through plural sockets 109A-109D.

A script file 105 has a providing section 115 which acquires data to be transmitted as well as a dividing section 116 and an allocating section 117 which perform division and allocation on the data to be transmitted through sockets 204A-204D.

Upon completion of establishment of connections of the sockets 204A-204D, the providing section 115 acquires, by a desired method, data to be transmitted and passes the acquired data to the dividing section 116.

The dividing section 116 divides the data in the same manner as the above-described dividing unit 111, and passes resulting divisional data to the allocating section 117. The allocating section 117 allocates the divisional data in the same manner as the above-described allocating unit 112, and sends the divisional data to the server 1 through the sockets 204A-204D. In the server 1, the received divisional data are passed to the collecting unit 118 through the sockets 109A-109D.

The collecting unit 118 collects the divisional data in the same manner as the above-described collecting section 106 and passes the collected divisional data to the combining unit 119. The combining unit 119 combines the divisional data together by the same method as the above-described combining section 107 and uses resulting combined data by a desired method. According to the above procedure, data can be transmitted from the client 2 to the server 1.

In the above embodiments, the dividing unit 111 adds pieces of division information to respective divisional data. The dividing unit 111 may also add an identification number (sequence number) for identification of a file to divisional data. This will be described below in more detail.

The above embodiments are directed to the case of transmitting the only one image file 104. Where plural files are to be transmitted in succession, when each of the plural files is divided into divisional data, an identification number may be added to the divisional data to indicate what file they belong to.

For example, where an image file “image1.jpg” is transmitted in the form of two divisional data and another image file “image2.jpg” is then transmitted also in the form of two divisional data, a total of four divisional data are generated.

Where only one data file is divided into two divisional data, the two divisional data can be discriminated from each other by simply giving division numbers “1/2” and “2/2.” On the other hand, where plural (two) data files are each divided into two divisional data with division numbers “1/2,” “2/2,” “1/2” and “2/2,” for example, division numbers “1/2” appear twice, and cannot be properly discriminated.

In view of above, pieces of information indicating that divisional data are data obtained by dividing two data files may be added, for example, as “1-1/2,” “1-2/2,” “2-1/2” and “2-2/2.”

Where plural files are to be transmitted in succession, they can be discriminated from each other by assigning such identification numbers to them, whereby the reception-side client 2 can combine the divisional data correctly.

In the above embodiments, the HTML file 103 and the script file 105 are stored in the storage unit 102 of the server 1 and the client 2 acquires them by HTTP requests. However, the invention is not limited to such a case. A modification is possible in which the client 2 holds both of the HTML file 103 and the script file 105 in advance and establishment of WebSocket connections by the establishing section 108 is started by executing the script file 105.

A further modification is possible in which the HTML file 103 and the script file 105 may be stored in an apparatus that is neither the server 1 nor the client 2 and the client 2 downloads these files from that apparatus and executes the script file 105.

The invention is not limited to the above embodiments themselves and, in the practice stage, may be embodied in such a manner that constituent elements are modified in various manners without departing from the spirit and scope of the invention. And various inventive concepts may be conceived by properly combining plural constituent elements disclosed in each embodiment. For example, several ones of the constituent elements of each embodiment may be omitted. Furthermore, constituent elements of different embodiments may be combined as appropriate.

Although the several embodiments of the invention have been described above, they are just examples and should not be construed as restricting the scope of the invention. Each of these novel embodiments may be practiced in various other forms, and part of it may be omitted, replaced by other elements, or changed in various manners without departing from the spirit and scope of the invention. These modifications are also included in the invention as claimed and its equivalents.

1. An information processing apparatus which sends data via plural sockets by connection-type communications in response to a data request from a request source apparatus, comprising:
a dividing unit which divides the data into plural divisional data, in terms of a division number of the plural divisional data or a data amount of each divisional data;
an allocating unit which allocates the divisional data produced by the dividing unit to the plural sockets; and
a providing unit which provides the request source apparatus with the divisional data allocated by the allocating unit and a script via the plural sockets,
wherein the script causes the request source apparatus to
establish communications to be performed with the information processing apparatus via the plural sockets,
collect the divisional data produced by the dividing unit, and
combine the collected divisional data together.

2. The information processing apparatus of claim 1,
wherein the script further causes the request source apparatus to request transmission of the data.

3. The information processing apparatus of claim 1,
wherein the dividing unit adds pieces of information indicating the number and order of respective divisional data produced by dividing a single data file.

4. The information processing apparatus of claim 1,
wherein, when dividing each of plural data files into divisional data, the dividing unit adds, to the divisional data, identification numbers indicating what data files the divisional data belong to.

5. The information processing apparatus of claim 1, further comprising:
a determining unit which determines the number of sockets that can be used simultaneously for communications with the request source apparatus.

6. The information processing apparatus of claim 5,
wherein the script further causes the request source apparatus to send, to the determining unit, a desired number of sockets to be used for communications with the request source apparatus, and the determining unit determines the number of sockets to be used for communications with the request source apparatus on the basis of the desired number of sockets received from the request source apparatus.

7. The information processing apparatus of claim 1,
wherein the providing unit sends the data according to a WebSocket standard.

8. An information processing system in which an information processing apparatus sends data via plural sockets by connection-type communications in response to a data request from a request source apparatus,
wherein the information processing apparatus comprises:
a dividing unit which divides the data into plural divisional data, in terms of a division number of the plural divisional data or a data amount of each divisional data;
an allocating unit which allocates the divisional data produced by the dividing unit to the plural sockets; and
a providing unit which provides the request source apparatus with the divisional data allocated by the allocating unit and a script via the plural sockets, and
wherein the request source apparatus comprises:
an execution unit which executes the script that is received from the information processing apparatus via the plural sockets, to thereby
establish communications to be performed with the information processing apparatus via the plural sockets,
collect the divisional data produced by the dividing unit, and
combine the collected divisional data together.
